(19) United States
(12) Patent Application Publication
(10) Pub. No.: US 2008/0115092 A1
(43) Pub. Date: May 15, 2008

(54) Addressing power supply voltage drops within an integrated circuit using on-cell capacitors

(76) Inventor: Pratheep A. Nair, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/598,327

(22) Filed: Nov. 13, 2006

(51) Int. Cl. G06F 17/50

(52) U.S. Cl. 716/1

(57) ABSTRACT

Herein described are at least a standard cell that is less prone to the negative effects of dynamic IR power supply voltage drops and a method of implementing the standard cell. The standard cell incorporates at least one on-cell capacitor positioned between a power supply rail and a ground rail. The at least one one-cell capacitor provides a charge reservoir for the standard cell to mitigate such dynamic IR power supply voltage drops. The method for implementing the standard cell comprises connecting at least one capacitor across a power supply rail to a ground rail of said standard cell. The at least one capacitor may be implemented by way of using a polysilicon layer and an N-well layer or by way of using a metal layer and an N-well layer.

### BACKGROUND OF THE INVENTION

Integrated circuit devices may utilize a number of functional blocks to implement one or more functions. Each functional block may comprise a plurality of standard cells. A standard cell may comprise a number of CMOS transistors used to implement a logic gate, for example. When these standard cells are operated at high frequencies, and/or burdened with high output loads, the voltage supply to these standard cells may be significantly reduced. For example, the power supply voltage may fluctuate as the transistors in a standard cell are switched at high frequencies. The power supply voltage may drop significantly as the transistors are switched. Furthermore, the presence of high output loads may result in significant current drain to a power supply rail of a standard cell, causing a power supply voltage drop. This drop in voltage may be referred to as a dynamic IR voltage drop. Furthermore, as the size of integrated circuit devices decreases, the voltage used to power these standard cells decreases, resulting in lower noise margins. As a result, these standard cells may be more vulnerable to circuit noise, such as power supply noise, for example.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a method for using one or more on-cell capacitors for reducing power supply voltage drops occurring within a standard cell. Various aspects of the invention provide a standard cell that is resistant to dynamic IR voltage drops. The various aspects and representative embodiments of the method and the standard cell are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a typical layout of an integrated circuit chip incorporating the use of a method that minimizes power supply voltage drops in standard cells located in one or more functional blocks, in accordance with an embodiment of the invention.

FIG. 2 is a relational block diagram of a portion of a functional block of an integrated circuit layout illustrating one or more standard cell rows, power supply rails, and ground rails, in accordance with an embodiment of the invention.

FIG. 3 is a circuit diagram depicting a modified standard cell that utilizes an on-cell capacitor to minimize power supply voltage drops, in accordance with an embodiment of the invention.

FIG. 4 is an operational flow diagram describing the creation of a library of modified standard cells, each of which incorporate one or more on-cell capacitors to reduce dynamic IR voltage drops, in accordance with an embodiment of the invention.

### DETAILED DESCRIPTION OF THE INVENTION

Various aspects of the invention provide a standard cell that is more resistant to dynamic IR voltage drops. The magnitude of a dynamic IR voltage drop may be dependent on the frequency of operation and the load encountered by the standard cell. For example, if the standard cell comprises an inverter, the rate in which its output switches will determine the extent of the voltage drop. Furthermore, the load presented to the output of the exemplary inverter will have an effect on the voltage drop. Furthermore, the various aspects of the invention provide a method for generating a standard cell that is resistant to such dynamic IR voltage drops.

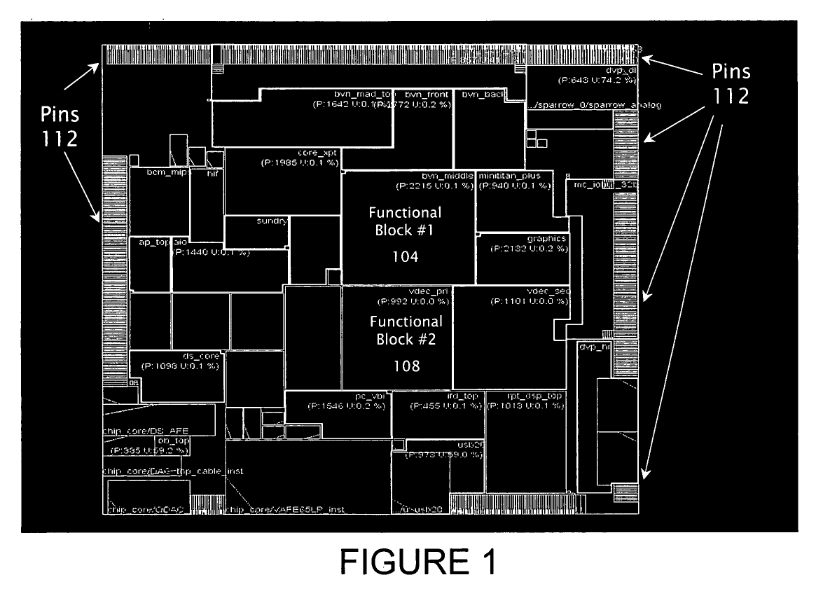

FIG. 1 is a typical layout of an integrated circuit chip incorporating a method that minimizes power supply voltage drops in standard cells, in accordance with an embodiment of the invention. The integrated circuit chip comprises a plurality of functional blocks and conductive pins 112. Each of the functional blocks comprises a plurality of standard cells. FIG. 1 illustrates a plurality of functional blocks within an integrated circuit chip of which two functional blocks 104, 108 are labeled. Although functional block #1 104 and functional block #2 108 are rectangular in shape, a functional block may be implemented using various shapes, as illustrated. Each functional block 104, 108 comprises a plurality of standard cells arranged in rows.

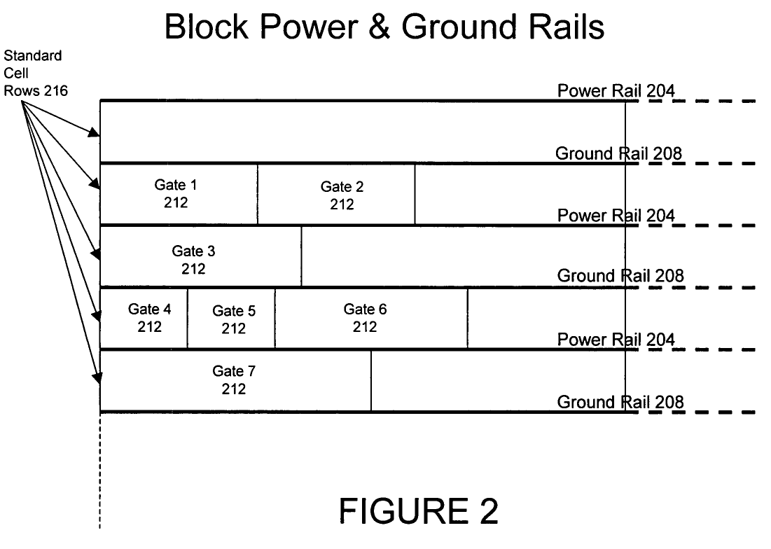

FIG. 2 is a relational block diagram of a portion of a functional block of an integrated circuit layout illustrating one or more standard cell rows 216, power supply rails 204, and ground rails 208, in accordance with an embodiment of the invention. FIG. 2 illustrates a plurality of gates 212 arranged over multiple standard cell rows 216. Each of the gates 212 comprises one or more standard cells. Each of the standard cell rows 216 is connected to its respective power supply rail 204 and ground rail 208. Of course, each of the one or more standard cells in a standard cell row is connected to its corresponding power supply rail 204 and ground rail 208. Although not shown, the power supply rail 204 and ground rail 208 may be connected to one or more pins at the periphery of the integrated circuit chip. The one or more pins may provide a conductive contact in which a power supply input may be provided. A standard cell comprises a rudimentary building block of a gate, for example. A standard cell may comprise a buffer or inverter, for example. The buffer may comprise a high power buffer capable of driving a number of inputs into other logic gates, for example. The functional block of FIG. 2 may be implemented using CMOS technology, for example. A 65 nanometer CMOS technology may be used that incorporates 1.0 V supply rails, for example.

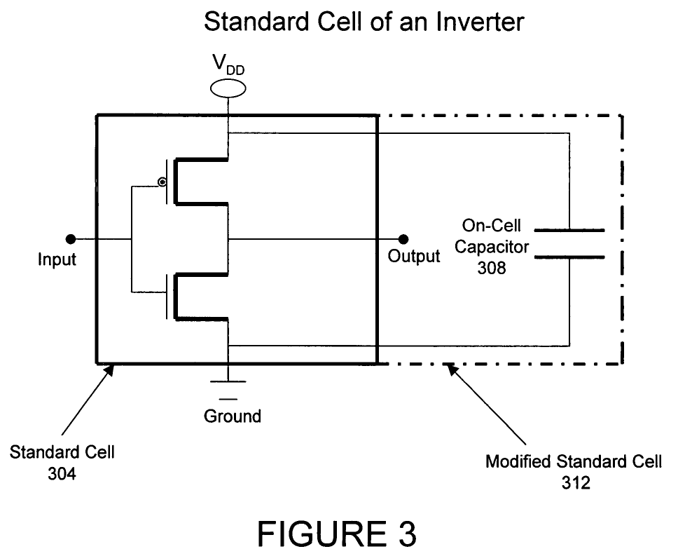

FIG. 3 is a circuit diagram depicting a modified standard cell 312 that utilizes an on-cell capacitor 308 to minimize power supply voltage drops, in accordance with an embodiment of the invention. A typical standard cell 304 may be used to implement a gate of an integrated circuit chip. In the representative embodiment of FIG. 3, the standard cell 304 comprises an inverter. The standard cell 304 or inverter (or CMOS switch) utilizes two field effect transistors that are tied together at their drains. A common input is provided at the gates of the two transistors. The source of the p-channel transistor is connected to V_{DD} while the source of the n-channel transistor is connected to ground. The standard cell 304 is indicated in solid lines. The modified standard cell 312 is indicated in solid and dotted lines. The dotted lines enclose an on-cell capacitor 308 that is used to minimize a dynamic IR voltage drop affecting a power supply rail. Energy stored on the on-cell capacitor 308 may be used to alleviate a dynamic IR voltage drop, for example. The energy stored in the on-cell capacitor may supply needed current when a voltage drop occurs. A voltage drop may result from high frequency switching of one or more transistors in the standard cell. When the transistors are driven during high frequency switching, the transistors may provide a very low resistance to ground. As a consequence, the transistors may short the power supply rail to ground, causing a significant dynamic IR voltage drop. The power supply voltage drop may be positively correlated to the frequency of switching of the transistors in a standard cell. Likewise, the power supply voltage drop may be positively correlated to the amount of load presented at the output a standard cell. The capacitance of the on-cell capacitor may be appropriately chosen minimize the dynamic IR voltage drops. The capacitance may be positively correlated to the frequency of switching of the standard cell 304. The capacitance may be positively correlated to the amount of load that is driven at the output of a standard cell 304. In a representative embodiment, the capacitance value of the on-cell capacitor is positively correlated to the frequency of switching of the transistors in the modified standard cell 312. Likewise, in a representative embodiment, the capacitance value of the on-cell capacitor is positively correlated to increases in the amount of load presented to the output of the modified standard cell 312. In a representative embodiment, the on-cell capacitor may be implemented using a polysilicon layer and an N-well layer of an integrated circuit chip. Alternatively, in a representative embodiment, the on-cell capacitor may be implemented using a metal layer and an N-well layer of an integrated circuit chip. The metal layer may comprise one of several metal layers on the integrated circuit chip. The two ends of the on-cell capacitor may be connected to its corresponding power supply rail and to its ground rail using via interconnects (not shown), for example.

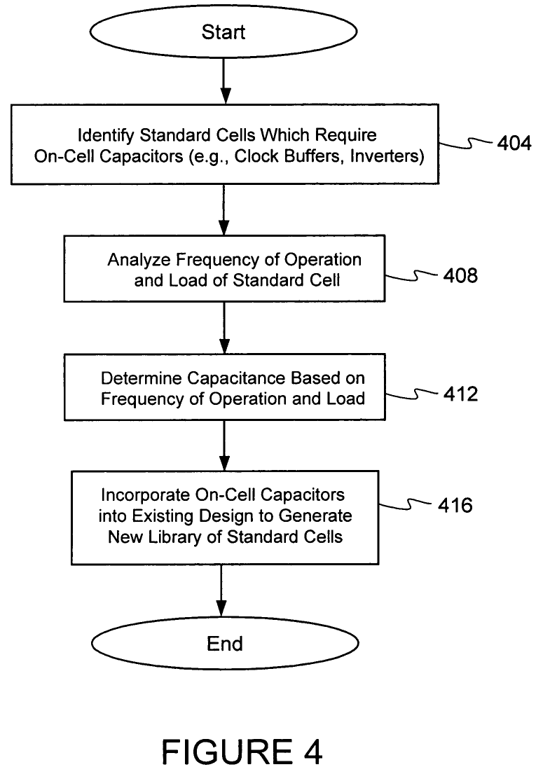

FIG. 4 is an operational flow diagram describing the creation of one or more modified standard cells, each of which incorporate one or more on-cell capacitors to reduce dynamic IR voltage drops, in accordance with an embodiment of the invention. The one or more modified standard cells may form a new library of modified standard cells. At step 404, one or more standard cells are analyzed and identified as benefiting from the incorporation of an on-cell capacitor. As previously discussed in connection with FIGS. 2 and 3, the on-cell capacitor may be used to create a modified standard cell. The one or more standard cells may comprise an inverter or a buffer, for example. Thereafter, at step 408, the frequency of operation and output load of each of the identified standard cells are analyzed. The frequency of switching of the transistors, as well as the load encountered at the output circuitry of the standard cell may be taken into consideration during the analysis and identification. Thereafter, at step 412, the appropriate capacitance is determined based on the frequency of operation and load of each of the identified standard cells. Next, at step 416, appropriately valued capacitors are incorporated or designed into the existing standard cells to generate a new library of modified standard cells. For example, the new library may comprise a modified standard cell of an inverter, or a modified standard cell of a buffer. Each modified standard cell utilizes an on-cell capacitor with an appropriate capacitance value, such that dynamic IR voltage drops are minimized or completely eliminated. The on-cell capacitor is typically connected across the power supply rail (e.g., V_{DD}) to ground of each of the modified standard cells.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of generating a standard cell used in designing an integrated circuit chip, said method comprising:
incorporating an on-cell capacitor that is connected from a power supply rail to ground rail of said standard cell, said on-cell capacitor used to minimize a power supply voltage drop affecting said standard cell.

2. The method of claim 1 wherein said standard cell comprises a buffer.

3. The method of claim 1 wherein said standard cell comprises an inverter.

4. The method of claim 1 wherein said power supply voltage drop results from high frequency switching of one or more transistors in said standard cell.

5. The method of claim 1 wherein said power supply voltage drop results from a load presented at the output circuitry of said standard cell.

6. The method of claim 1 wherein a capacitance of said on-cell capacitor is determined based on a frequency of switching of one or more transistors in said standard cell and an amount of load presented at the output of said standard cell.

7. The method of claim 6 wherein said power supply voltage drop is positively correlated to said frequency and said amount of load.

8. The method of claim 6 wherein said capacitance is positively correlated to said frequency and said amount of load.

9. The method of claim 1 wherein said integrated circuit is implemented using CMOS technology.

10. The method of claim 9 wherein said CMOS technology comprises 65 nanometer technology utilizing 1.0 Volt power supply rails.

11. The method of claim 1 wherein said on-cell capacitor is implemented using a polysilicon layer and an N-well layer of said integrated circuit chip.

12. The method of claim 1 wherein said on-cell capacitor is implemented using a metal layer and an N-well layer of said integrated circuit chip.

13. A standard cell used in designing an integrated circuit chip comprising:
an on-cell capacitor connected from a power supply rail to a ground rail of said standard cell, said on-cell capacitor capable of reducing power supply voltage drops to said standard cell.

14. The standard cell of claim 13 wherein a capacitance of said capacitor is determined by a frequency of operation of said standard cell and load encountered by said standard cell.

15. The standard cell of claim 13 wherein said standard cell comprises a buffer.

16. The standard cell of claim 13 wherein said standard cell comprises an inverter.

17. The standard cell of claim 13 wherein said power supply voltage drops are proportional to a frequency of switching of one or more transistors of said standard cell.

18. The standard cell of claim 13 wherein said power supply voltage drops are proportional to an amount of load presented to an output of said standard cell.

19. The standard cell of claim 13 wherein said integrated circuit chip is implemented using CMOS technology.

20. The standard cell of claim 19 wherein said CMOS technology comprises a 65 nanometer technology.

21. The standard cell of claim 13 wherein said on-cell capacitor stores energy for supplying current when said power supply voltage drops occur.
